(19) United States
(12) Patent Application Publication
(10) Pub. No.: US 2026/0066681 A1
(43) Pub. Date: Mar. 5, 2026

(54) BATTERY SYSTEM WITH OPEN WIRE DETECTION AND ASSOCIATED INTEGRATED CIRCUIT

(71) Applicant: Chengdu Monolithic Power Systems Co., Ltd., Chengdu (CN)

(72) Inventor: Shuai Wang, Hangzhou (CN)

(21) Appl. No.: 19/310,265

(22) Filed: Aug. 26, 2025

(30) Foreign Application Priority Data
Aug. 28, 2024 (CN) 202411194636.4

(51) Int. Cl. H02J 7/00

(52) U.S. Cl. CPC H02J 7/685; H02J 7/56; H02J 7/80; H02J 7/96

(57) ABSTRACT

A battery system with an integrated circuit and a battery group is provided. The integrated circuit has a first terminal to receive a power supply voltage, a second terminal coupled to a reference ground, a first cell terminal operable to be coupled to a cathode of a first battery cell through a first connection line, a second to (n+1)th cell terminals operable to be respectively coupled to an anode of the first battery cell to an anode of a nth battery cell of the battery group through a second to (n+1)th connection lines; a first switch coupled between the first cell terminal and the second terminal, a second to (n+1)th switches operable to be respectively coupled in parallel with the first to nth battery cells of the battery group, a (n+2)th switch coupled between the first terminal and the (n+1)th cell terminal.

### CROSS-REFERENCE TO RELATED APPLICATIONS

This application claims the benefit of CN application 202411194636.4, filed on Aug. 28, 2024, and incorporated herein by reference.

### TECHNICAL FIELD

The present invention generally relates to electronic circuits, and more particularly but not exclusively, to battery systems with open wire detection and associated integrated circuits.

### BACKGROUND

A battery group is composed of a certain number of battery cells. By connecting multiple battery cells in series, the voltages of the multiple battery cells are accumulated, thereby achieving a high output voltage as needed. In practical applications, when a battery management circuit is used to manage the battery group, there are a plurality of connection lines between the multiple cells of the battery group and the battery management circuit. Those connection lines between one or more cells and the battery management circuit may have a bad or open connection at a random moment. There will be a need to be able to detect the open connection on those connection lines, to ensure stable performance.

### SUMMARY

There has been provided, in accordance with an embodiment of the present disclosure, an integrated circuit for a battery group. The integrated circuit comprises a first terminal configured to receive a supply voltage, a second terminal configured to be coupled to a reference ground, a first cell terminal operable to be coupled to a cathode of a first battery cell of the battery group through a first connection line, a second to (n+1)th cell terminals operable to be respectively to an anode of the first battery cell to an anode of a nth battery cell of the battery group through a second to (n+1)th connection lines, a first switch coupled between the first cell terminal and the second terminal, a second to (n+1)th switches operable to be respectively coupled in parallel with the first to nth battery cells of the battery group, a (n+2)th switch coupled between the first terminal and the (n+1)th cell terminal. The integrated circuit is configured to detect an open wire event among the first to (n+1)th connection lines.

There also has been provided, in accordance with an embodiment of the present disclosure, a battery system. The battery system has a battery group and an integrated circuit. The integrated circuit comprises a first terminal configured to receive a supply voltage, a second terminal configured to be coupled to a reference ground, a first cell terminal operable to be coupled to a cathode of a first battery cell of the battery group through a first connection line, a second to (n+1)th cell terminals operable to be respectively coupled to an anode of the first battery cell to an anode of a nth battery cell of the battery group through a second to (n+1)th connection lines, a first switch coupled between the first cell terminal and the second terminal, a second to (n+1)th switches operable to be respectively coupled in parallel with the first to nth battery cells of the battery group, a (n+2)th switch coupled between the first terminal and the (n+1)th cell terminal. The integrated circuit is configured to detect the open wire event among the first to (n+1)th connection lines.

### BRIEF DESCRIPTION OF DRAWINGS

The present invention can be further understood with reference to the following detailed description and the appended drawings, wherein like elements are provided with like reference numerals.

FIG. 1 illustrates a schematic block diagram of a battery system with open wire detection in accordance with an embodiment of the present disclosure.

FIG. 2 illustrates a schematic circuit diagram of a battery system with open wire detection in accordance with an embodiment of the present disclosure.

FIG. 3 illustrates a flow diagram of a method 300 for detecting an open connection between an integrated circuit and cells of a battery group in accordance with an embodiment of the present disclosure.

FIG. 4 illustrates a circuit diagram of a battery system with open wire detection in accordance with an embodiment of the present disclosure.

FIG. 5 illustrates a working waveform diagram of the battery system shown in FIG. 4 in accordance with an embodiment of the present disclosure.

### DETAILED DESCRIPTION

Reference will now be made in detail to the preferred embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be obvious to one of ordinary skill in the art that the present invention may be practiced without these specific details. In other instances, well-known methods, procedures, components, and circuits have not been described in detail so as not to unnecessarily obscure aspects of the present invention.

Reference to “one embodiment”, “an embodiment”, “an example” or “examples” means: certain features, structures, or characteristics are contained in at least one embodiment of the present invention. These “one embodiment”, “an embodiment”, “an example” and “examples” are not necessarily directed to the same embodiment or example. Furthermore, the features, structures, or characteristics may be combined in one or more embodiments or examples. In addition, it should be noted that the drawings are provided for illustration, and are not necessarily to scale. And when an element is described as “connected” or “coupled” to another element, it can be directly connected or coupled to the other element, or there could exist one or more intermediate elements. In contrast, when an element is referred to as “directly connected” or “directly coupled” to another element, there is no intermediate element.

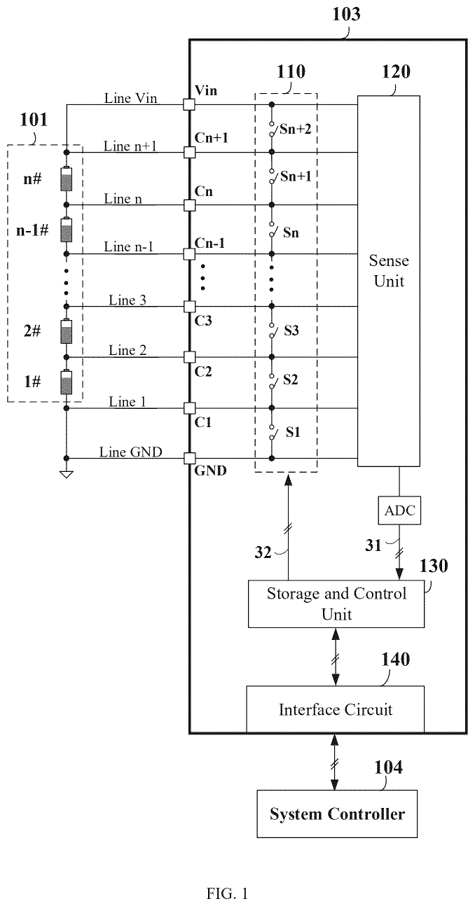

FIG. 1 illustrates a schematic block diagram of a battery system with open wire detection in accordance with an embodiment of the present disclosure. As shown in FIG. 1, the battery system comprises a battery group 101, an integrated circuit 103, and a system controller 104. The battery group 101 includes a plurality of battery cells connected by ordinal in a series structure. The plurality of battery cells are coupled between a positive battery group terminal and a negative battery group terminal. The battery system shown in FIG. 1 is configured to detect an open connection between the integrated circuit 103 and battery cells of the battery group 101.

In an example shown in FIG. 1, the battery group 101 comprises n battery cells, i.e., a first battery cell, a second battery cell, . . . , a nth battery cell, which are connected by ordinal in a series structure. Wherein n is an integer higher than 2 or equal to 2. In an example, the battery group 101 is used for providing a high voltage, wherein n is an integer higher than or equal to 30.

In an example shown in FIG. 1, the integrated circuit 103 comprises a plurality of terminals, a set of switches 110, a sense unit 120, a storage and control unit 130 and an interface circuit 140. As shown in FIG. 1, the plurality of terminals include a first terminal Vin, a second terminal GND, and a first to (n+1)th cell terminals (C1˜Cn+1). The first terminal Vin is configured to receive a supply voltage of the integrated circuit 103 via a connection line (Line Vin). The supply voltage provides power to the integrated circuit 103. The second terminal GND is configured to be coupled to a reference ground via a connection line (Line GND). The first cell terminal C1 is operable to be coupled to a cathode of the first battery cell through a first connection line (i.e., Line 1). Similarly, a second cell terminal C2 is operable coupled to an anode of the first battery cell through a second connection line (i.e., Line 2), a third cell terminal C3 is operable coupled to an anode of the second battery cell through a third connection line (i.e., Line 3), . . . , a nth cell terminal Cn is operable coupled to an anode of a (n−1)th battery cell through a nth connection line (i.e., Line n), and a (n+1)th cell terminal Cn+1 is operable coupled to an anode of a nth battery cell through a (n+1)th connection line (i.e., Line n+1). In sum, the second to (n+1)th cell terminals (C2 to Cn+1), are operable to be respectively coupled through the second to (n+1)th connection lines (Line 2 to Line n+1) to the anode of the first battery cell to the anode of the nth battery cell.

Referring still to FIG. 1, the set of switches 110 comprises n+2 switches (i.e., S1 to Sn+2) to perform the open wire detection in an open wire detection mode. A first switch S1 is coupled between the first cell terminal C1 and the second terminal GND. A (n+2)th switch Sn+2 is coupled between the first terminal Vin and the (n+1)th cell terminal Cn+1. A second switch S2 is operable to be coupled in parallel with the first battery cell, a third switch S3 is operable to be coupled in parallel with the second battery cell, . . . , a nth switch Sn is operable to be coupled in parallel with the (n−1)th battery cell, and a (n+1)th switch Sn+1 is operable to be coupled in parallel with the nth battery cell. In sum, the second to (n+1)th switches (S2 to Sn+1) are operable to be respectively coupled in parallel with the first to nth battery cells. In a further embodiment, the second to the (n+1)th switches (S2 to Sn+1) of the integrated circuit 103 are further configured as balance switches for balancing the battery group 101, to ensure the cell voltages are substantially equal among the battery cells of the battery group 101 during a battery balance mode.

The sense unit 120 is configured to collect the cell voltage information of each single battery cell in the battery group 101, through the first terminal Vin, the second terminal GND, and the n+1 cell terminals C1˜Cn+1. The integrated circuit 103 is configured to operate in the open wire detection mode or the battery balance mode. In response to the open wire detection mode, the switches S1˜Sn+2 of the set of switches 110 are sequentially ON one by one in a preset order with a time interval between successive ON of every two switches. In one embodiment, the time interval is programable. During each time interval, the sense unit 120 is configured to sense a voltage across each switch that has already ON in the open wire detection mode. For example, a voltage VS1 across the first switch S1, a voltage VS2 across the second switch S2 and a voltage VS3 across the third switch S3 are all sensed during the time interval between successive ON of the third switch S3 and a fourth switch S4. In one embodiment, during each time interval, the sense unit 120 is configured to perform the voltage sense after a preset delay TD. In an embodiment, the preset delay TD could be constant. In another embodiment, the preset delay TD may be programmable by the system controller 104.

In response to entering the open wire detection mode, the storage and control unit 130 is configured to provide an open wire detection control signal 32 to control the n+2 switches of the set of switches 110 successively ON one by one in the preset order. The storage and control unit 130 is configured to identify an open wire event among the first to (n+1)th connection lines (Line 1 to Line n+1) based on the sensed voltages.

In one embodiment, if the difference between the voltage VSi across a ith switch Si in the current time interval and the voltage VSi across the ith switch Si in the previous time interval exceeds a threshold voltage, the open wire event is identified on the connection line that is coupled between the ith cell terminal Ci and the cathode of the ith battery cell, wherein 1≤i≤n.

In one embodiment, if the difference between the voltage across the (n+1)th switch in the current time interval and the voltage across the (n+1)th switch in the previous current time interval exceeds the threshold voltage, the open wire event is identified on the connection line that is coupled between the (n+1)th cell terminal Cn+1 and the anode of the nth battery cell.

In the embodiment shown in FIG. 1, the integrated circuit 103 further comprise an analog to digital converting circuit ADC. The analog to digital converting circuit ADC is configured to convert the sensed voltage in the current time interval to a voltage digital signal 31, the voltage digital signal 31 is stored in the storage and control unit 130.

In one embodiment, the storage and control unit 130 may be configured to store the digital signal of the sensed voltage in the previous time intervals. In another embodiment, the storage and control unit 130 may be configured to store open wire state bits indicative of the open wire event of the connection lines Line 1 to Line n+1.

As shown in FIG. 1, the storage and control unit 130 is coupled to the system controller 104 through the interface circuit 140. The system controller 104 communicates with the integrated circuit 103, is configured to receive the sensed voltage information and open wire state bits stored in the storage and control unit 130, and to provide an open wire indication signal when the open wire event is identified.

In an example, the system controller 104 is coupled to the sense unit 120 and is configured to receive and monitor a battery cell voltage of every battery cell, to perform battery status estimation of each battery cell. The system controller 104 is further configured to provide a balance control signal to the storage and control unit 130, to control the balance switches (S2˜Sn+1) for meeting the balance requirements of the battery group 101 in the battery balance mode. In an example, the system controller 104 controls the energy to be transferred from the battery cell with the highest voltage in the battery group 101 to other battery cells in the battery group 101. In another embodiment, the system controller 104 is configured to transfer energy to the battery cell with the lowest voltage in the battery group 101 from other battery cells in the battery group 101, until the balance among the n battery cells of the battery group 101 is reached. In one embodiment, one of the balance switches S2˜Sn+1 is selectively activated in the battery balance mode.

In one embodiment, an isolation circuit may be inserted between the system controller 104 and the integrated circuit 103. In one embodiment, the isolation circuit may comprise opto-coupler, transformer, capacitor or any other suitable electrical isolation device.

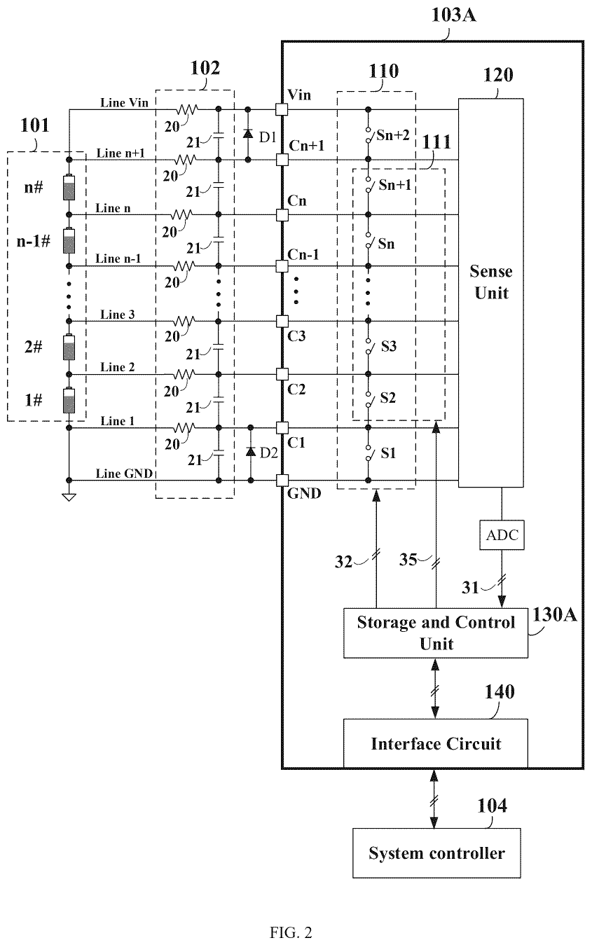

FIG. 2 illustrates a schematic circuit diagram of a battery system with open wire detection in accordance with an embodiment of the present disclosure.

Compared with the battery system shown in FIG. 1, the battery system shown in FIG. 2 further comprises a connection circuit 102.

As shown in FIG. 2, the connection circuit 102 comprises n+2 RC networks with a same or similar structure. In one embodiment, each RC network includes a resistor 20 and a capacitor 21. Each RC network has a first terminal that is respectively coupled to one of the first terminal Vin and the cell terminals C1˜Cn+2, and a second terminal that is respectively coupled to the anode or the cathode of the battery cells of the battery group 101.

In the example shown in FIG. 2, the battery system further comprise diodes D1 and D2, as shown in FIG. 2. An anode of the diode D1 is coupled to the (n+1)th cell terminal Cn+1, a cathode of the diode D1 is coupled to the first terminal Vin. In one embodiment, a first open wire event is identified on the connection line (Line Vin) by detecting if the diode D1 is forward biased.

As shown in FIG. 2, an anode of the diode D2 is coupled to the second terminal GND, a cathode of the diode D2 is coupled to the first cell terminal C1. In one embodiment, a second open wire event is identified on the connection line (Line GND) by detecting if the diode D2 is forward biased.

In the example shown in FIG. 2, the set of switches 110 includes the first switch to the (n+2)th switch (S1˜Sn+2). The set of switches 110 is configured to perform the open wire detection under the control of the open wire detection control signal 32. The switches S1˜Sn+2 in the set of switches 110 are sequentially ON one by one in a preset order with a time interval between successive ON of every two switches of the set of switches 110.

During each time interval, the sense unit 120 is configured to sense a voltage across each switch that has already ON in the open wire detection mode. In an example, a voltage VS1 across the first switch S1, a voltage VS2 across the second switch S2 and a voltage VS3 across the third switch S3 are all sensed during the time interval between successive ON of the third switch S3 and a fourth switch S4.

The switches S2˜Sn+1 are further configured as balance switches. In the example shown in FIG. 2, the set of balance switches 111 includes balance switches S2˜Sn+1. In other words, the second switch to the (n+1)th switch S2˜Sn+1 are shared by the set of switches 110 and the set of balance switches 111. The set of balance switches 111 is configured to perform the balance control under the control of the balance control signal 35 provided by the storage and control unit 130 in the battery balance control mode. In one embodiment, in response to entering the battery balance mode, the balance switches S2˜Sn+1 work with an energy transfer unit (not shown) to perform the battery balance function. The energy transfer unit, for example, may be a boost or buck converter.

In accordance with an exemplary embodiment of the present invention, a method for detecting an open connection between the integrated circuit 103A and n battery cells of the battery group 101 may be provided. The method comprises the following steps. The first terminal Vin of the integrated circuit 103A is configured to receive the power voltage. The second terminal GND is configured to be coupled to the reference ground. The first cell terminal C1 is operable to be coupled to the cathode of the first battery cell through the first connection line (Line 1). The second to (n+1)th cell terminals C2˜Cn+1 are operable to be respectively coupled to the anode of the first battery cell to an anode of a nth battery cell through the second to (n+1)th connection lines (Line 2˜Line n+1). The first switch S1 is coupled between the first cell terminal C1 and the second terminal GND. The second to (n+1)th switches S2˜Sn+1 are operable to be respectively coupled in parallel with the first to nth battery cells of the battery group 101. The (n+2)th switch Sn+1 is coupled between the first terminal Vin and the (n+1)th cell terminal Cn+1. The integrated circuit 103A is configured to detect the open wire event among the connection lines (Line 1˜Line n+1). In one embodiment, the switches S1˜Sn+1 are controlled to be ON successively one by one in the preset order with the time interval between successive ON of every two switches. The voltage across each switch that has already ON can be sensed in the open wire detection mode. The open wire event among the first to (n+1)th connection lines is identified based on the sensed voltages in the current time interval and the previous time interval.

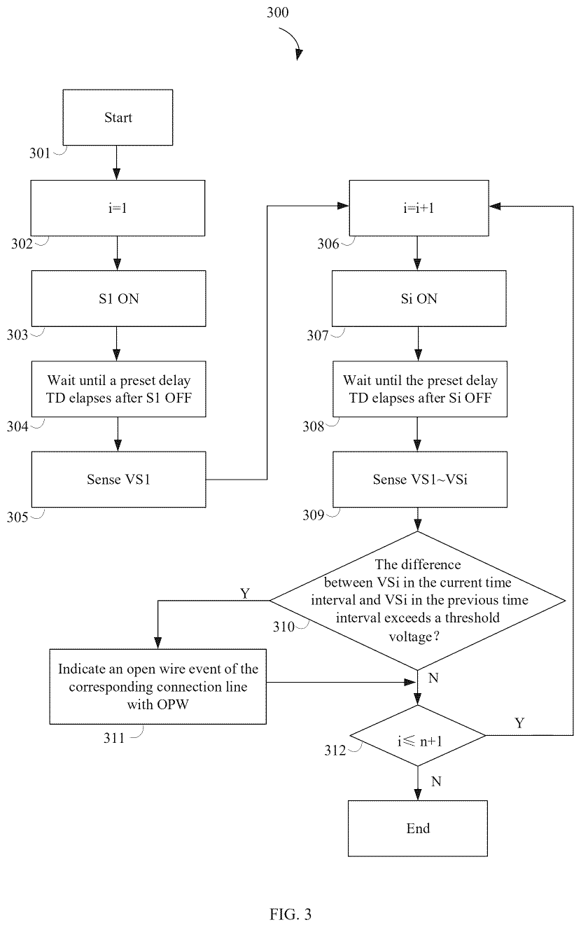

In detail, FIG. 3 illustrates a flow diagram of a method 300 for detecting an open connection between an integrated circuit and cells of a battery group in accordance with an embodiment of the present disclosure. In the example shown in FIG. 3, the method 300 comprises steps 301˜312. The details of the embodiment will be described with reference to FIG. 3.

At step 301, in response to the open wire detection mode, the integrated circuit 103A is configured to detect the open wire event among the connection lines (Line 1˜Line n+1) coupled between the integrated circuit 103A and the n battery cells of the battery group 101. For ease of description and understanding, a preset variable i is used.

At step 302, the open wire detection starts from i=1.

At step 303, the first switch S1 coupled between the first cell terminal C1 and the second terminal GND is controlled to be ON firstly, a voltage across the capacitor 21 is discharged through the first switch S1. In the example shown in FIG. 2, the capacitor 21 is coupled in parallel with the first switch S1. In another example, the capacitor 21 is parasitic capacitance coupled in parallel with the first switch S1.

At step 304, after the first switch S1 is turned off, wait until a preset delay TD elapses. During the preset delay TD, if there is no open connection on the connection line (Line 1), the first battery cell will recharge the capacitor 21.

At step 305, the sense unit 120 senses the voltage VS1 across the first switch S1 after the preset delay TD elapses.

The method 300 starts to enter a loop operation from step 306 to 312. At step 306, for each iteration of the loop, the preset variable i is added by 1, i.e., i=i+1.

At step 307, the ith switch Si is controlled to be ON.

At step 308, after the ith switch Si is turned off, wait until the preset delay TD elapses.

At step 309, the sense unit 120 senses the voltage across each switch that has already ON in the open wire detection mode(i.e., VS1˜VSi).

At step 310, if the difference between the voltage VSi across the ith switch in the current time interval and the voltage VSi across the ith switch in the previous time interval exceeds a threshold voltage Vth, the open wire event is identified on the connection line (Line i) that is coupled between the ith cell terminal and the cathode of the ith battery cell, wherein 1≤i≤n. If the difference between the voltage across the (n+1)th switch in the current time interval and the voltage across the (n+1)th switch in the previous current time interval exceeds the threshold voltage, the open wire event is identified on the connection line that is coupled between the (n+1)th cell terminal Cn+1 and the anode of the nth battery cell. When the open wire event is identified, go to step 311. Otherwise, go to step 312, and repeat the loop operation. Until the preset variable i is added to excess n+1, i.e., i>n+1, the open wire detection mode ends.

At step 311, the identified connection line can be marked with OPW to indicate the open wire event.

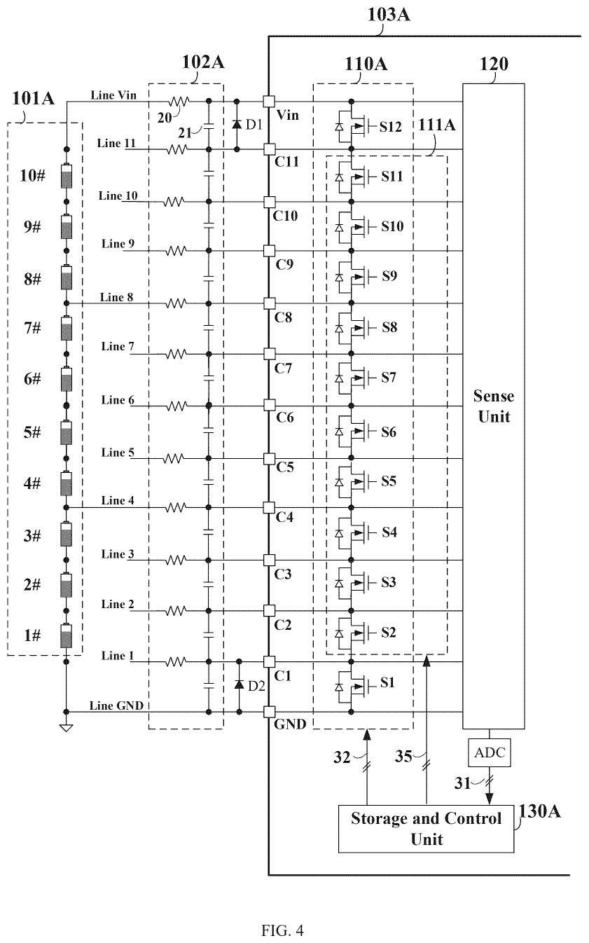

FIG. 4 illustrates a circuit diagram of a battery system with open wire detection in accordance with an embodiment of the present disclosure. In the example shown in FIG. 4, the battery system comprises a battery group 101A, a connection circuit 102A, and an integrated circuit 103A. The battery group 101A comprises 10 battery cells including a first battery cell, a second battery cell, . . . , a tenth battery cell. However, the number 10 of the battery cells is just to provide an example and not intended to be limiting. In another example, the battery group 101A may comprise dozens of battery cells, e.g., 32 battery cells.

In the example shown in FIG. 4, the integrated circuit 103A comprises a plurality of terminals, a set of switches 110A, a sense unit 120, and a storage and control unit 130. As shown in FIG. 4, the plurality of terminals include a first terminal Vin, a second terminal GND, and a first to eleventh cell terminals C1˜C11.

As shown in FIG. 4, the first terminal Vin is configured to receive a supply voltage. The second terminal GND is configured to be coupled to a reference ground of the integrated circuit 103A. The first cell terminal C1 is operable to be coupled to a cathode of the first battery cell through a first connect line (Line 1). Similarly, the second to eleventh cell terminals C2˜C11 are operable to be respectively coupled through a second to eleventh connection line (Line 2˜Line 11) to an anode of the first battery cell to an anode of the tenth battery cell. The connection circuit 102A comprises 12 RC networks, as illustratively shown in FIG. 4.

Referring still to FIG. 4, the set of switches 110 includes switches S1˜S12 for performing open wire detection. The first switch S1 is coupled between the first cell terminal C1 and the second terminal GND. The second to eleventh switches S2˜S11 are operable to be respectively coupled in parallel with the first to tenth battery cells. The twelfth switch S12 is coupled between the first terminal Vin and the eleventh cell terminal C11. In a further embodiment, the second to eleventh switches S2˜S11 form a set of balance switches 110A, are configured to balance the battery cells of the battery group 101A in the battery balance mode, so that cell voltages are substantially equal among the battery cells of the battery group 101A.

In an embodiment, the sense unit 120 may monitor a battery cell voltage of every battery cell, to perform battery status estimation. The integrated circuit 103A is configured to detect the open wire event among the connection lines (Line 1˜Line 11). In one embodiment, in response to entering the open wire detection mode, the storage and control unit 130A controls the switches S1˜S12 ON successively one by one in the preset order with the time interval between successive ON of every two switches. The voltage across each switch that has already ON can be sensed by the sense unit 120 in the open wire detection mode. The open wire event among the first to eleventh connection lines (Line 1˜Line 11) can be identified by the storage and control unit 130 based on the sensed voltages in the current time interval and the previous time interval.

In one embodiment, if the difference between the voltage across the ith switch in the current time interval and the voltage across the ith switch in the previous current time interval exceeds the threshold voltage Vth, the open wire event is identified on the connection line coupled between the ith cell terminal and the cathode of the ith battery cell, wherein 1≤i≤n.

If the difference between the sensed voltage across the (n+1)th switch in the current time interval and the sensed voltage across the (n+1)th switch in the previous current time interval exceeds the threshold voltage Vth, the open wire event is identified on the connection line coupled between the (n+1)th cell terminal and the anode of the nth battery cell.

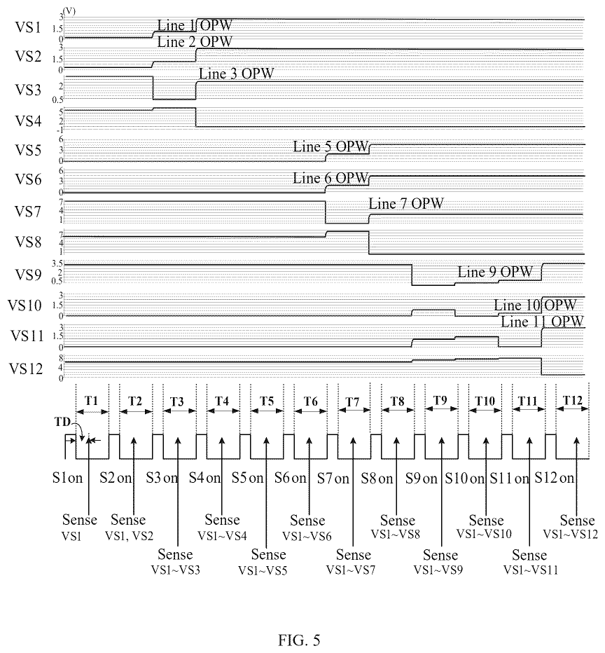

FIG. 5 illustrates a working waveform diagram of the battery system shown in FIG. 4 in accordance with an embodiment of the present disclosure. As shown in FIG. 5, the set of switches 110A includes switches S1˜S12 that are ON successively one by one in the preset order with a time interval between successive ON of every two switches. A voltage across each switch that has already ON is sensed during each time interval (i.e., one of T1˜T12 shown in FIG. 5) in the open wire detection mode. In one embodiment, during each time interval, the sense unit 120 performs the voltage sense after the preset delay TD. In one example, the voltage VS1˜VS7 are sensed during the time interval T7 after a seventh switch S7 becomes OFF from ON.

Referring to FIG. 5, the voltage across each switch of the set switches 110A are sensed and shown. The sensed voltage in the current time interval is compared with the sensed voltage in the previous time interval. If the difference between the voltage across the ith switch in the current time interval and the voltage across the ith switch in the previous current time interval exceeds the threshold voltage Vth, the open wire event is identified on the connection line coupled between the ith cell terminal and the cathode of the ith battery cell, wherein 1≤i≤n. If the difference between the voltage across the (n+1)th switch in the current time interval and the voltage across the (n+1)th switch in the previous current time interval exceeds the threshold voltage Vth, the open wire event is identified on the connection line coupled between the (n+1)th cell terminal and the anode of the nth battery cell. In one embodiment, the threshold voltage Vth approaches 0V or slightly higher than 0V.

In an example, during the current time interval T3, the difference between the voltage VS1 across the first switch S1 in the current time interval T3 and the voltage VS1 in the previous current time interval T2 exceeds the threshold voltage Vth, the open wire event is identified on the connection line (Line 1), and “Line 1 OPW” is marked as shown in FIG. 5.

In an example, during the current time interval T3, the difference between the voltage VS2 across the second switch S2 in the current time interval T3 and the voltage VS2 in the previous time interval T2 exceeds the threshold voltage Vth, the open wire event is identified on the connection line (Line 2), and “Line 2 OPW” is marked as shown in FIG. 5.

In an example, during the current time interval T4, the difference between the voltage VS3 across the third switch S3 in the current time interval T4 and the voltage VS3 in the previous time interval T3 exceeds the threshold voltage Vth, the open wire event is identified on the connection line (Line 3), and “Line 3 OPW” is marked as shown in FIG. 5.

In an example, the difference between the voltage VS4 across the fourth switch S4 in the current time interval and VS4 in the previous current time interval is always less than the threshold voltage Vth, the open wire event on the connection line (Line 4) will not happen.

In this document, relational terms such as first and second, and the like may be used solely to distinguish one entity or action from another entity or action without necessarily requiring or implying any actual such relationship or order between such entities or actions. Numerical ordinals such as “first,” “second,” “third,” etc. simply denote different singles of a plurality and do not imply any order or sequence unless specifically defined by the claim language.

Obviously, many modifications and variations of the present invention are possible in light of the above teachings. It is therefore to be understood that within the scope of the appended claims the invention may be practiced otherwise than as specifically described. It should be understood, of course, the foregoing disclosure relates only to a preferred embodiment (or embodiments) of the invention and that numerous modifications may be made therein without departing from the spirit and the scope of the invention as set forth in the appended claims. Various modifications are contemplated, and they obviously will be resorted to by those skilled in the art without departing from the spirit and the scope of the invention as hereinafter defined by the appended claims as only a preferred embodiment(s) thereof has been disclosed.

What is claimed is:

1. An integrated circuit for a battery group, comprising:
a first terminal, configured to receive a supply voltage;
a second terminal, configured to be coupled to a reference ground;
a first cell terminal, operable to be coupled to a cathode of a first battery cell of the battery group through a first connection line;
a second to (n+1)th cell terminals, operable to be respectively coupled to an anode of the first battery cell to an anode of a nth battery cell of the battery group through a second to (n+1)th connection lines;
a first switch, coupled between the first cell terminal and the second terminal;
a second to (n+1)th switches, operable to be respectively coupled in parallel with the first to nth battery cells of the battery group;
a (n+2)th switch, coupled between the first terminal and the (n+1)th cell terminal; and
wherein the integrated circuit is configured to detect an open wire event among the first to (n+1)th connection lines.

2. The integrated circuit of claim 1, further comprising:
a storage and control unit, configured to control the first to (n+2)th switches ON successively in a preset order with a time interval between successive ON of every two switches in response to entering an open wire detection mode;
a sense unit, during each time interval, the sense unit is configured to sense a voltage across each switch that has already ON in the open wire detection mode; and
wherein the storage and control unit is configured to identify the open wire event among the first to (n+1)th connection lines based on the sensed voltages.

3. The integrated circuit of claim 2, wherein during each time interval, the sense unit is configured to perform the voltage sense after a preset delay.

4. The integrated circuit of claim 2, wherein:
if the difference between the voltage across a ith switch in the current time interval and the voltage across the ith switch in the previous time interval exceeds a threshold voltage, the open wire event is identified on the connection line that is coupled between the ith cell terminal and the cathode of the ith battery cell, wherein 1≤i≤n; and
if the difference between the voltage across the (n+1)th switch in the current time interval and the voltage across the (n+1)th switch in the previous current time interval exceeds the threshold voltage, the open wire event is identified on the connection line that is coupled between the (n+1)th cell terminal and the anode of the nth battery cell.

5. The integrated circuit of claim 2, further comprises:
an analog to digital converting circuit configured to convert the sensed voltage in the current time interval into a voltage digital signal and to store the voltage digital signal in the storage and control unit.

6. The integrated circuit of claim 2, wherein the storage and control unit is further configured to store the sensed voltage in the previous time interval.

7. The integrated circuit of claim 2, wherein the storage and control unit is further configured to store open wire state bits indicative of the open wire event among the first to (n+1)th connection lines.

8. The integrated circuit of claim 1, wherein in response to entering a battery balance mode, the second to (n+1)th switches of the integrated circuit are further configured as balance switches for balancing the battery group.

9. A battery system, comprising:
a battery group; and
an integrated circuit, comprising:
a first terminal, configured to receive a supply voltage;
a second terminal, configured to be coupled to a reference ground;
a first cell terminal, operable to be coupled to a cathode of a first battery cell of the battery group through a first connection line;
a second to (n+1)th cell terminals, operable to be respectively coupled to an anode of the first battery cell to an anode of a nth battery cell of the battery group through a second to (n+1)th connection lines;
a first switch, coupled between the first cell terminal and the second terminal;
a second to (n+1)th switches, operable to be respectively coupled in parallel with the first to nth battery cells of the battery group;
a (n+2)th switch, coupled between the first terminal and the (n+1)th cell terminal; and
wherein the integrated circuit is configured to detect an open wire event among the first to (n+1)th connection lines.

10. The battery system of claim 9, wherein the integrated circuit further comprises:
a storage and control unit, configured to control the first to (n+2)th switches ON successively one by one in a preset order with a time interval between successive ON of every two switches in response to entering an open wire detection mode;
a sense unit, during each time interval, the sense unit is configured to sense a voltage across each switch that has already ON in the open wire detection mode; and
wherein the storage and control unit is configured to identify the open wire event among the first to (n+1)th connection lines based on the sensed voltages.

11. The battery system of claim 10, wherein during each time interval, the sense unit is configured to perform the voltage sense after a preset delay.

12. The battery system of claim 10, wherein:
if the difference between the voltage across the ith switch in the current time interval and the voltage across the ith switch in the previous current time interval exceeds a threshold voltage, the open wire event is identified on the connection line that is coupled between the ith cell terminal and the cathode of the ith battery cell, wherein 1≤i≤n; and
if the difference between the voltage across the (n+1)th switch in the current time interval and the voltage across the (n+1)th switch in the previous current time interval exceeds the threshold voltage, the open wire event is identified on the connection line that is coupled between the (n+1)th cell terminal and the anode of the nth battery cell.

13. The battery system of claim 10, further comprises:
an analog to digital converting circuit configured to convert the sensed voltage in the current time interval into a voltage digital signal and to store the voltage digital signal in the storage and control unit.

14. The battery system of claim 10, wherein the storage and control unit is configured to store the sensed voltage in the previous time interval.

15. The battery system of claim 10, wherein the storage and control unit is configured to store open wire state bits indicative of the open wire event among the first to (n+1)th connection lines.

16. The battery system of claim 9, further comprises:
a system controller, configured to communicate with the integrated circuit and to provide an open wire indication signal when the open wire event is identified.

17. The battery system of claim 9, further comprises:
a connection circuit, having n+2 RC networks, each RC network is connected to one of the first terminal and the first to (n+1)th cell terminals, respectively.

18. The battery system of claim 9, further comprises:
a first diode having an anode and a cathode, wherein the anode of the first diode is coupled to the (n+1)th cell terminal, the cathode of the first diode is coupled to the first terminal of the integrated circuit, and a first open wire event is identified on a connection line between the first terminal and the anode of the nth battery cell by detecting if the first diode is forward biased.

19. The battery system of claim 9, further comprises:
a second diode having an anode and a cathode, wherein the anode of the second diode is coupled to the second terminal, the cathode of the second diode is coupled to the first cell terminal, and a second open wire event is identified on a connection line between the second terminal and the reference ground by detecting if the second diode is forward biased.

20. The battery system of claim 10, wherein the integrated circuit is configured to work in the open wire detection mode or a battery balance mode, and in response to entering the battery balance mode, the second to (n+1)th switches of the integrated circuit are further configured as balance switches for balancing the battery group.
